(19) United States
(12) Patent Application Publication
(10) Pub. No.: US 2008/0232217 A1
(43) Pub. Date: Sep. 25, 2008

(54) METHOD AND OPTICAL DISC DRIVE FOR ACCESSING DATA ON OPTICAL STORAGE MEDIUM

(75) Inventor: Guang-Hwa Tarng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/039,753

(22) Filed: Feb. 29, 2008

(30) Foreign Application Priority Data
Mar. 22, 2007 (TW) 96109880

(51) Int. Cl. G11B 7/135; G11B 7/00

(52) U.S. Cl. 369/53.35; 369/44.23

(57) ABSTRACT

A method and optical disc drive for accessing data on optical storage medium are provided. The optical disc drive includes a sled motor and an optical pickup head. When the sled motor performs a track positioning, the optical pickup head uses a differential astigmatic detection (DAD) method to generate a focus error signal. When the track positioning is finished, the optical pickup head is switched to an astigmatic detection (AD) method to generate the focus error signal to assist to access data on an optical storage medium. Therefore, it can greatly reduce reading and writing errors of the optical disc drive.

### CROSS-REFERENCE TO RELATED APPLICATION

This application claims the priority benefit of Taiwan application serial No. 96109880, filed on Mar. 22, 2007. The entirety the above-mentioned patent application is hereby incorporated by reference herein and made a part of specification.

### BACKGROUND OF THE INVENTION

1. Field of the Invention

The invention relates to an optical disc drive and, more particularly, to a method and an optical disc drive for accessing data on an optical storage medium.

2. Description of the Related Art

As the information age comes, to deal with large amount of digital data with different formats, compact discs with the advantages of large storage capacity, fast accessing speed, easily to be carried, and convenient to be stored become common storage media. Accordingly, optical disc drives for accessing data of the compact discs become necessary.

An optical disc drive uses laser beams emitted by an optical pickup head to write and read data. When the optical disc drive reads or writes the data on a compact disc, the laser beams have to be focused and tracked on a proper position of the compact disc. In this process, there are two important servo signals. One is a focus error (FE) signal perpendicular to the compact disc and indicating errors of the laser beams focused on the compact disc; the other is a tracking error (TE) signal in the radial direction of the compact disc and indicating errors of the laser beams tracked on a track of the compact disc.

The FE signal can be generated in two ways. One is an astigmatic detection (AD) method, and the other is a differential astigmatic detection (DAD) method. The AD method generates a signal by a main beam of the optical pickup head; the DAD method generates a signal according to the main beam and side beams beside the main beam.

However, the AD method has serious defects. When the optical disc drive reads the data on the compact disc, the FE signal generated by the AD method is easily affected by the TE signal if a seeking happens. That is, the FE signal generates coupling whose frequency is the same with the TE signal, which causes the servo signal unstable and even causes a reading error.

For the DAD method, the coupling is not obvious since the sum of the main beam and the side beams can eliminate the coupling. However, the DAD method has a more serious defect. The DAD method generates the FE signal according to the side beams beside the main beam besides the main beam. Therefore, when the optical disc drive performs the focusing control, the FE signal is affected by the side beams, which easily makes the focusing position diverge. This greatly reduces the quality of the data read and written by the optical disc drive. Even the compact discs burned by the optical disc drive may fail to be read.

### BRIEF SUMMARY OF THE INVENTION

The invention provides a method for accessing (reading or writing) data on an optical storage medium to reduce reading and writing errors.

The invention provides an optical disc drive to improve the quality of data read and written by the optical disc drive.

The invention provides a method for accessing data in an optical storage medium. The method includes: the step of generating a laser beam with a predetermined wavelength range; the step of using a differential astigmatic detection (DAD) method to generate a focus error signal during seeking the laser beam with the predetermined wavelength range on a track of the optical storage medium; and. The step of switching to an astigmatic detection (AD) method to generate the focus error signal after seeking the laser beam on the track of the optical storage medium to assist to access data of the track.

In one embodiment, in the AD method, the focus error signal is generated according to a main beam. Further, in the DAD method, the FE signal is generated according to the main beam and a pair of side beams.

Further, the invention provides an optical disc drive for accessing data on an optical storage medium. The optical disc drive according to the invention includes an optical pickup head and a sled motor. The optical pickup head can use a differential astigmatic detection (DAD) method or an astigmatic detection (AD) method to assist to access (read or write) data on the optical storage medium and to generate a light sensing signal. The sled motor is coupled to the optical pickup head to adjust the optical pickup head to focus on the track of the optical storage medium. The optical pickup head is switched to the DAD method to generate a focus error signal when the sled motor performances a track positioning. The optical pickup head is switched to the AD method to generate the focus signal to assist to access the data on the optical storage medium when the track positioning is finished.

In one embodiment, the optical pickup head of the optical disc drive includes a laser diode and a photo detector. The laser diode generates a laser beam with a predetermined wavelength range to focus on the optical storage medium. The photo detector receives the laser beam with the predetermined wavelength range reflected by the optical storage medium.

The optical disc drive according to the invention can further include a light amplifier, a digital signal processing unit, and a drive circuit. The light amplifier is coupled to the optical pickup head and can generate a light amplifying signal, a FE signal, and a tracking error (TE) signal according to the light sensing signal. The digital signal processing unit is coupled to the light amplifier and outputs a control signal according to the light amplifying signal, the FE signal, and the TE signal. The drive circuit is coupled to the optical pickup head, the sled motor, and the digital signal processing unit and drives the optical pickup head and the sled motor according to the control signal.

Generally speaking, the track positioning of the optical disc drive according to the invention includes positioning a tracking, seeking a track, or crossing a track.

Further, the AD method used by the optical pickup head generates the focus error signal according to a main beam, and the DAD method used by the optical pickup head generates the focus error signal according to a main beam and a pair of side beams.

In the invention, the DAD method is used to position the laser beam with the predetermined wavelength range on the track of the optical storage medium. Further, the work method is switched to the AD method to read or write data from the track. Therefore, the invention can greatly reduce the reading and writing errors.

These and other features, aspects, and advantages of the present invention will become better understood with regard to the following description, appended claims, and accompanying drawings.

### BRIEF DESCRIPTION OF THE DRAWINGS

FIG. 1 is a structural diagram showing an optical disc drive according to a first embodiment of the invention.

FIG. 2 is a flow chart showing a method for accessing data on an optical storage medium according to a first embodiment of the invention.

FIG. 3 is a structural diagram showing an optical disc drive according to a second embodiment of the invention.

### DETAILED DESCRIPTION OF THE EMBODIMENTS

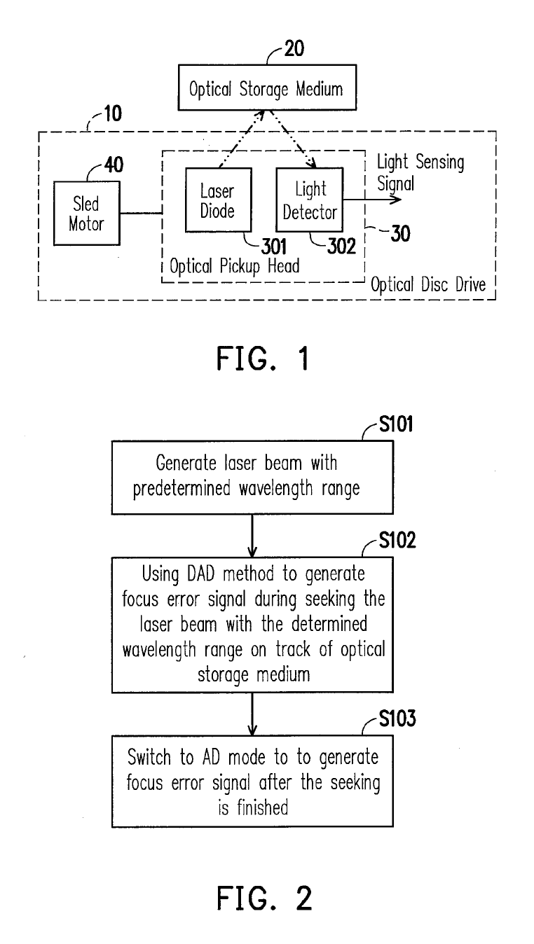

FIG. 1 is a structural diagram showing an optical disc drive according to a first embodiment of the invention. The optical disc drive 10 provided by the preferred embodiment of the invention can be used to access (read or write) data on an optical storage medium 20. The optical storage medium 20 may be a compact disc (CD), a digital versatile disc (DVD), a blue-ray disc, or other media using optical methods to store digital data. The optical disc drive 10 includes an optical pickup head 30 and a sled motor 40. In this embodiment, the optical pickup head 30 can use a differential astigmatic detection (DAD) method or an astigmatic detection (AD) method to access the data on the optical storage medium 20 and to generate a light sensing signal. The sled motor 40 is coupled to the optical pickup head 30 to adjust the optical pickup head to focus on the track of the optical storage medium.

The optical pickup head 30 may include a laser diode (LD) 301 and a photo detector (PD) 302. The laser diode 301 is used to generate a laser beam with a predetermined wavelength range to focus on the optical storage medium 20. The photo detector 302 is used to receive the laser beam with the predetermined wavelength range reflected by the optical storage medium 20.

The AD method used by the optical pickup head 30 may access the data on the optical storage medium 20 to generate a focus error (FE) signal according to a main beam. The DAD method used by the optical pickup head 30 may access the data on the optical storage medium 20 to generate the FE signal according to the main beam and a pair of side beams.

FIG. 2 is a flow chart showing a method for accessing data on an optical storage medium according to a first embodiment of the invention. Please refer to FIG. 1 and FIG. 2 together. First, in step S101, the optical pickup head 30 generates the laser beam with a predetermined wavelength range. The optical pickup head 30 generates the laser beams with the predetermined wavelengths and power in the different range. The optical pickup head 30 can access data on the different type of optical storage medium 20. For example, when the wavelength of the laser beam is 780 nm, the optical pickup head 30 can read the CD. Further, for example, when the wavelength of the laser beam is 650 nm, the optical pickup head 30 can read the DVD.

Then in step S102, when the sled motor 40 performs the track positioning (positioning a tracking, seeking, or crossing a track), the optical pickup head 30 uses the DAD method to generate a focus error (FE) signal to assist to position the laser beam with the predetermined wavelength range on the track of the optical storage medium.

It can greatly reduce coupling on the FE signal from the tracking error (TE) signal to improve the quality of the data read from or written to the optical storage medium 20 by the optical disc drive 10. Further, the track positioning performed by the sled motor 40 can include positioning a track, seeking a track, or crossing a track. In the other aspect, the track positioning performed by the sled motor 40 can be considered as moving the focusing position of the optical pickup head 30 to the objective track on the optical storage medium 20.

Then in step S103, when the sled motor 40 finishes the track positioning, the optical pickup head 30 switches the DAD method to the AD method to generate the FE signal to assist to access the data on the track of the optical storage medium 20. It can avoid affecting the FE signal by the side beams to raise the precision of the focusing position and thus to improve the quality of the data read from or written to the optical storage medium 20 by the optical disc drive 10.

Although the above embodiment has described a possible pattern of the optical disc drive 10 and the method for reading or writing the data in the optical storage medium 20, persons having ordinary skill in the art should know that, for different manufacturers, structure of the optical disc drive 10 and steps of the method for accessing data in the optical storage medium 20 are different. Therefore the invention is not limited thereto. That is, as long as the optical disc drive 10 and the method for reading or writing the data in the optical storage medium 20 use the DAD method to generate the FE signal during performing the track positioning and use the AD method to generate the FE signal during after finishing the track positioning the data, they all conform to the spirit of the invention.

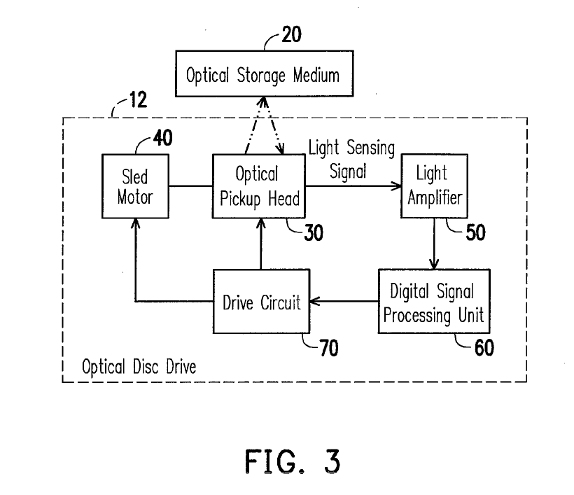

Persons having ordinary skill in the art also can modify the structure of the optical disc drive according to the spirit of the invention and the teaching of the aforementioned embodiments. For example, FIG. 3 is a structural diagram showing an optical disc drive according to a second embodiment of the invention. In FIG. 3, the optical disc drive 12 includes an optical pickup head 30, a sled motor 40, a light amplifier 50, a digital signal processing unit 60 and a drive circuit 70. In this embodiment, the optical storage medium 20, the optical pickup head 30, and the sled motor 40 have been described in the aforementioned embodiments, and here they are not described for concise purpose.

The light amplifier 50 can be coupled to the optical pickup head 30 and generate a light amplifying signal, a FE signal, and a TE signal according to the light sensing signal. The digital signal processing unit 60 can be coupled to the light amplifier 50 and output a control signal according to the light amplifying signal, the FE signal, and the TE signal. Further, the drive circuit 70 can be coupled to the optical pickup head 30, the sled motor 40, and the digital signal processing unit 60. The drive circuit 70 can drive the optical pickup head 30 and the sled motor 40 according to the control signal. As long as the optical pickup head 30 uses the DAD method to generate the FE signal during the track positioning and uses the AD method to generate the FE signal after finishing the track positioning, the coupling which affects the FE signal from the TE signal can be reduced, and the FE signal can avoid being affected by the side beams. This improves the quality of the data read from or written to the optical storage medium 20 by the optical disc drive 12.

To sum up, the embodiments of the invention at least have the following advantages.

First, the optical disc drive performs the track positioning in the differential astigmatic detection method. Therefore, it can greatly reduce the coupling which affects the FE signal from the TE signal to improve the quality of the data read from or written to the optical storage medium by the optical disc drive.

Second, the optical disc drive reads and writes the data on the track of the optical storage medium in the astigmatic detection method. Therefore, the FE signal can avoid being affected by the side beams, which raises the precision of the focusing position and thus improves the quality of the data read from or written to the optical storage medium by the optical disc drive.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for accessing data on an optical storage medium, comprising the steps of:
generating a laser beam with a predetermined wavelength range;
using a differential astigmatic detection (DAD) method to generate a focus error signal during seeking the laser beam with the predetermined wavelength range on a track of the optical storage medium; and
switching to an astigmatic detection (AD) method to generate the focus error signal after seeking the laser beam on the track of the optical storage medium to assist to access data of the track.

2. The method for accessing data on an optical storage medium according to claim 1, wherein the focus error signal is generated according to a main beam in the AD method.

3. The method for accessing data on an optical storage medium according to claim 1, wherein the focus error signal is generated according to a main beam and a pair of side beams in the DAD method.

4. The method for accessing data on an optical storage medium according to claim 1, wherein the optical storage medium is a compact disc, a digital versatile disc, or a blue-ray disc.

5. An optical disc drive for accessing data on an optical storage medium, the optical disc drive comprising:
an optical pickup head using a differential astigmatic detection (DAD) method or an astigmatic detection (AD) method to assist to access data on the optical storage medium and to generate a light sensing signal; and
a sled motor coupled to the optical pickup head to adjust the optical pickup head to focus on the track of the optical storage medium,
wherein the optical pickup head is switched to the DAD method to generate a focus error signal when the sled motor performances a track positioning and the optical pickup head is switched to the AD method to generate the focus signal to assist to access the data on the optical storage medium after finishing the track positioning.

6. The optical disc drive according to claim 5, wherein the optical pickup head comprises:
a laser diode, generating a laser beam with a predetermined wavelength range to focus on the optical storage medium; and
a photo detector, receiving the laser beam with the predetermined wavelength range reflected by the optical storage medium.

7. The optical disc drive according to claim 5, further comprising:
a light amplifier coupled to the optical pickup head, the light amplifier generating a light amplifying signal, the focus error signal, and a tracking error signal according to the light sensing signal;
a digital signal processing unit coupled to the light amplifier, the digital signal processing unit outputting a control signal according to the light amplifying signal, the focus error signal, and the tracking error signal; and
a drive circuit coupled to the optical pickup head, the sled motor, and the digital signal processing unit, the drive circuit driving the optical pickup head and the sled motor according to the control signal.

8. The optical disc drive according to claim 5, wherein the track positioning comprises positioning a tracking, seeking, or crossing a track.

9. The optical disc drive according to claim 5, wherein the optical pickup head using the AD method generates the focus error signal according to a main beam.

10. The optical disc drive according to claim 5, wherein the optical pickup head using the DAD method generates the focus error signal according to a main beam and a pair of side beams.

11. The optical disc drive according to claim 5, wherein the optical storage medium is a compact disc, a digital versatile disc, or a blue-ray disc.
